(19) United States
(12) Patent Application Publication
(10) Pub. No.: US 2026/0257869 A1
(43) Pub. Date: Sep. 3, 2026

(54) TRANSPORT MODULE

(71) Applicant: Anheuser-Busch InBev S.A., Brussels (BE)

(72) Inventors: Glenn FERREIRA, Leuven (BE); Philippe Jean Marie DUPERRAY, Châteauroux (FR)

(21) Appl. No.: 18/995,745

(22) PCT Filed: Jul. 25, 2023
(86) PCT No.: PCT/EP2023/070645

§ 371 Date: Jan. 16, 2025

(30) Foreign Application Priority Data
Jul. 27, 2022 (BE) 2022/5601

(51) Int. Cl. B65G 35/06

(52) U.S. Cl. CPC B65G 35/06; B65G 2203/0283

(57) ABSTRACT

A transport module for a product transport system, wherein the transport module is mountable on a curvilinear guide rail, the transport module comprising: a rotary drive motor in torque communication with a drive wheel; a power module electrically connected to the rotary drive motor and configured to receive electrical power contactlessly from a power supply rail, wherein the power module is configured to be untethered with respect to the power supply rail; and a control module in communication with the rotary drive motor, the control module comprising a bi-directional wireless communication device configured to receive a control signal and transmit status data; and a position sensing module configured to detect the position of the transport module. A product transport system comprising a transport module.

The present invention relates to a transport module for a product transport system, and to a product transport system.

Various solutions exist in the art for moving products through multiple different locations. One such example is where a product is moved through a series of workstations on a production line.

Known solutions for such moving of products include e.g. linear drive systems. However, there are a number of drawbacks associated with these existing systems.

Regarding linear drive systems, these systems, although accurate, are very high-cost, take up a relatively large amount of space, and lack flexibility, being restricted to planar tracks having supplier set track geometries and tolerances. Specifically, linear drive systems lack track route flexibility, dimensionally and spatially, due to the physics associated with this type of drive system. In particular, maintaining an adequate electro-magnetic connection between transport module and track requires maintaining a relatively constant and minimized offset (clearance gap) between motor coils along the track and all the permanent magnets mounted on the transport module on the track; and this becomes highly challenging for product transporting, moving and handling where the need exists to deviate from a linear context. Existing linear drive systems suffer reduced propulsion force and/or motion control precision into, through and out of curves, as well as between at zones across motor joints resulting in variations in system performance about the restricted to linear or planar tracks.

In addition and in general, existing systems also lack load bearing capacity, affordability and/or scalability. Therefore, a need exists to overcome one or more of the disadvantages associated with existing solutions, whether mentioned in this document or otherwise.

The disclosed invention relates to an untethered, rail mountable, self-propelled, product transport module, and product transport system. The module being able to be self-propelled along complex three dimensional curvilinear rails in an unrestrained, independent, and bi-directional manner, regardless of the near or far ranging distance between module and rail, and independent of the linear, planar or three dimensional shaped route of the rail.

According to a first aspect of the invention there is provided a transport module for a product transport system. The transport module may be mountable on a curvilinear guide rail. The transport module comprising:
a rotary drive motor in torque communication with a drive wheel;
a power module electrically connected to the rotary drive motor and configured to receive electrical power contactlessly from a power supply rail, wherein the power module is configured to be untethered with respect to the power supply rail; and
a control module in communication with the rotary drive motor, the control module comprising a bi-directional wireless communication device configured to receive a control signal and transmit status data; and
a position sensing module configured to detect the position of the transport module.

The combination of features described above allows the transport module to operate on geometrically complex rail routes, which rails at the same time do not necessarily need the precision with which the prior art guide rails must be manufactured to guarantee performance. This invention therefore brings greater flexibility of use, scalability and more affordable rail cost, providing for broader and more frequent use.

Within the context of the present invention, the products carried by the transport module, may include: materials, components, items, parts, assemblies, articles; empty or full primary (packaging) containers; finished products, secondary packages (in assembly or finished assembled); application brackets, holders, jigs, clamps; powered and controlled transportation module-mounted sensors and/or devices, for example, linear and/or rotary actuators, motors, pumps and compressors.

Within the context of the present invention, the wording “transport module” and “transport system” are not to be taken as limiting to the action of mere transporting a product, but defines any action, or combination of actions, to which such product is or must be subjected, during its travel on the module on the rail track, such actions including without limitation: packaging assembly, e.g. blank selection, transport, folding, gluing, labelling, drying; selection, manipulation and packaging of products, primary packaging and secondary packaging; delivery and processing of products, primary or secondary packaging; and the deployment, relocation and use of tooling such as sensor equipment, manipulation equipment, handling equipment and treatment equipment.

The present product transport system may be described via a local x, y and z axis coordinate system relative to the curvilinear rail directly opposite the transportation module (as opposed to the global X, Y, Z axis coordinate triad static to the environment in which the rail is statically mounted, with the X and Y axes being horizontal and the Z axis vertically up, following the right hand rule). The local x-axis is defined parallel to the guide rail and in the direction of travel of the transport module along the guide rail. The local y-axis is perpendicular to the x-axis and typically perpendicular to the primary device mounting surface of the transport module. The z-axis is perpendicular to the x and y axes.

The transport module may otherwise be referred to as a motorised mover, or an independent motorised cart. The transport module may be described as being untethered in that there are no cables, wires, tubes, hoses, cable management systems or the like, tethering (e.g. fixing or anchoring) the transport module to any stationary unit (e.g. the guide rail), or otherwise limiting the range and/or freedom of movement of the transport module. The inductive power module may be a contactless power transfer system. The wireless communication device of the control module may be referred to as a wireless client. The wireless system may be described as a bi-directional, deterministic, low latency, low jitter, optionally synchronized, machine automation communication system. The transport module may be said to be movable along the supporting and guiding rail (i.e. the guide rail). The control module may be electrically connected to the rotary drive motor and/or may communicate with the rotary drive motor wirelessly.

The transport module may be suitable for use on, and mountable on, a guide rail. The guide rail may be curvilinear. That is, a rail that may include curves in all three-dimensions. The combination of rotary drive motor, power module, control module and position sensing module may allow the transport module to be mountable on a curvilinear guide rail. The guide rail may be a curvilinear support and guidance rail. Allowing for left, right, up, down corners and corners of various constant and/or varying radii, clothoids, chambered corners, corkscrew barrel roles, spiral ups or downs again at constant or varying radius.

The power module may be an inductive power module configured to receive electrical power wirelessly. Advantageously, the contactless inductive power module mitigates the risk of the power supply to the transport module being disrupted due to dust or debris contaminating the power supply rail. The power module may comprise a power pickup for contactlessly (i.e. without physical contact) receiving electrical power. The power module may be configured to receive electrical power contactlessly from a power supply conductor. The power supply rail or power supply conductor may be associated with and/or mounted parallel to the guide rail.

Advantageously, the incorporation of the rotary drive motor as part of the transport module provides greatly reduced cost in comparison to, for example, having to lay linear motors along an entire length of a track (as is the case in e.g. linear motor systems). The associated cost per metre of the overall product transport system is therefore greatly reduced as a result. The functions of precision motor coil/permanent magnet gap maintenance vs transport module support and guidance are separated permitting the use of standard precision rotary bearings within a choice of drive motor and the use of more economical rail systems configured for the application and/or further adapted for a specific zone within an application.

The drive wheel may comprise a spur pinion or roller pinion for engaging a rack or roller rack associated with the guide rail.

The drive wheel may be a mechanical power transmission system to propel the transport module along the guide rail. The use of a rotary drive motor and drive wheel on the transport module was found to provide great flexibility in the geometry of the track defined by the curvilinear guide rail. This is because a self-propelled transport module system was found to be more tolerant of non-linear geometries than a linear drive system where the interaction between electric coil generated magnetic flux and that of the mover mounted permanent magnets is immediately and adversely affected via curvature (convexed or concaved), away from straight (linear). It was observed that the power transmission of the drive motor faithfully follows the track, accommodating 3-dimensional curvatures +/−y and +/−z with +/−x being in the positive or negative directions of travel, respectively. It was observed that the transport module can propel along any curvilinearity of a track, maintaining constant power capacity and performance through the curves and along the straights, with the electro-magnetic interactions of the rotor and stator or the drive motor being maintained in close and constant interaction via precision rotary bearings, independent of the transport module support and guidance rail. In comparison, with existing linear drive systems, it is not possible to propel on 3-dimensional complex parts in the track (such as e.g. a banked corner) without the system losing power and/or precision of motion control in those parts.

Within the context of the present invention, the wording “rail” can be mono-, bi-, tri, quad or multi-rail.

The incorporation of a control module on the transport module means that the transport module is independently controllable of any other surrounding transport module. A centrally-located controller (e.g. a machine controller) may interface with the control modules of a plurality of transport modules to allow independent control of each transport module. For example, this can give rise to variable pitch functionality where a separation between adjacent transport modules is to be adjusted as needed. The use of a wireless communication device (e.g. receiver (Client)) of the control module also increases the reliability of communication, regardless of the location or environment in which the module is operating, since it does not require-for example-a physical connection to a communications slip rail.

Further advantages associated with the transport module and product transport system include: a lower mass per unit length in comparison to prior art systems, as linear motors do not need to be located all along the entire guide rail; the option to incorporate corrosion resistant guide rails (e.g. 304L stainless steel); improved accessibility for maintenance; and improved load carrying capacity. In comparison to existing solutions, the transport module(s) are also modular—e.g. they can be introduced and removed from the wider system as required, without adaptation of the wider system (e.g. the other modules or track). Cost savings are also realised.

The product transportation system incorporates means of determining the position of the transport module that management of motion (velocity and acceleration/deceleration) can be executed in an absolute sense of relative to a paired or otherwise related set of transport modules. The position sensing may be remote (global) and serving all or a set of transport modules on a track or local to each transport module, providing positional feedback direct to the local motor controller via the wireless communication system to the central control system.

The position sensing module may determine the location of the transport module along the guide rail. The position sensing module may be configured to report the position of the transport module, e.g. the position of the transport module along the guide rail.

Position determination of a transport module may be realized in a number of ways, including without limitation: position detection of the transport module independently of the rail (e.g. a GPS system, or other radio system); position detection using a beacon; the position sensing module may be a contactless position sensing module (e.g. be optical and/or magnetic); or may be a mechanical position sensing module e.g. interacting with the rail.

Advantageously, the position sensing module can be used to detect the position of the transport module in an absolute sense—e.g. using GPS to determine the location of the module; and/or in a relative sense—e.g. using a series of gates on the guide rail to identify the module such that the position of the module with respect to the rail can be determined. This provides input into the control module and to the central controller to control the motion of the individual transport modules relative each other and along the curvilinear track.

The transport module may further comprise a guide wheel engageable with the guide rail.

Guide wheel is intended to refer to a wheel which is not driven. A guide wheel may otherwise be described as a passive wheel. The guide wheel may comprise a contact surface, engageable with the guide rail. The guide wheel, contact surface and/or guide rail may be or comprise a polymeric material (e.g. being manufactured from a polymer, such as rubber or an abrasion resistant, load bearing elastomer). The guide wheel itself (as a whole) may be polymeric. The incorporation of at least a polymeric liner in any wheel is advantageous in reducing the noise level in operation in comparison to, for example, metal-on-metal caster noise levels; and additionally avoids needing rail lubrication.

Advantageously, the incorporation of a guide wheel engageable with the guide rail reduces the risk that the transport module becomes detached from the guide rail. Described another way, the guide wheel and drive wheel may co-operate with one another to locate and retain the transport module on, about, or along, the guide rail. This may ensure a minimum contact pressure, and hence sufficient traction, of the drive wheel with the rail or means of mechanical propulsion in appropriate engagement with the rail mounted counter-part.

The transport module may comprise a single guide wheel or, more preferably, comprises a plurality of guide wheels. The guide wheels alone or in combination with any drive wheel arrangement are configured to allow movement of the transport module along the supporting and guiding curvilinear track while maintaining the transport module opposite and working surface (face) parallel to the rail at all times. If the power transmission is a mechanically engaged propulsion system different to the load supporting frictional drive wheel arrangement, the guide wheel arrangement serves to support, attach and maintain orientation of the transport module on, along and relative to the rail, thereby also ensuring continuous engagement of any mechanically intersecting power transmission system.

The transport module may further comprise a first array of guide wheels engageable with the guide rail, the first array of guide wheels comprising the guide wheel.

An array of guide wheels is intended to mean a plurality of guide wheels which engage the same guide rail. The drive wheel preferably engages the same guide rail as the first array of guide wheels.

Incorporating a plurality of guide wheels contributes to the locating, support, orientation and/or retention of the transport module on the guide rail. The plurality of guide wheels can be arranged to constrain movement of the transport module in a plane perpendicular to the guide rail—for example by ensuring a minimum contact pressure, and hence sufficient traction, of the drive wheel with the rail or for example maintaining a certain orientation and alignment (within a given tolerance) for any mechanically coupled power transmission system to properly engage. The plurality of guide wheels may be arranged to maintain alignment of the module—for example by resisting rotation of the transport module about an axis (or all axes) parallel, or perpendicular to, the guide rail.

The plurality of guide wheels, array of guide wheels or plurality of arrays of guide wheels may comprise a combination of fixed axle guide wheels and floating (e.g. biased) axle guide wheels. Fixed axle guide wheels may be configured to assist in supporting and maintaining position and orientation of the transport module and any fixtures, devices and/or payloads mounted thereon, relative to the rail. The floating axle guide wheels may be configured to assist in accommodating geometric tolerances and inconsistent surface finishes of the cross sections of the individual guide rails, as well as any dimensional tolerances between individual rails making up any load bearing guide rail structure (e.g. lattice beam arrangement).

A plurality of guide wheels is beneficial in compensating for any local deformation, or variation, in the dimensions and/or surface finish of the guide rail. One contributing factor to this is due to the plurality of guide wheels being able to provide points of contact between the rail and the module in different planes/orientations. Described another way, by incorporating a first array of guide wheels, the guide rail does not have to comply with the typical tolerance requirements known in the art (including surface finish)—for example as those required for linear drives—which now can be substantially reduced, resulting in a significant cost per metre saving; e.g. known systems have the typical requirement that the guide rails have to be of precision, case or through hardened and ground steel, which no longer is the case with the present invention. In another way, the invention embodies a separation of guidance function from electro-magnet motor coil vs magnet gap management. In the embodiment, the transport module is supported and guided upon a lower specification, lower cost per unit length curvilinear rail while the motor coil vs magnet interaction is separately maintained via cost effective rotary motor bearings (e.g. ball or roller bearings).

At least a subset of the first array of guide wheels may be circumferentially offset with respect to the drive wheel.

At least a subset of the first array of guide wheels being circumferentially offset with respect to the drive wheel may otherwise be described as the at least a subset of the first array of guide wheels being arranged in different positions around the guide rail. For each array of guide wheels, the guide wheels, in combination with the drive wheel (if applicable), may be substantially equally distributed about the guide rail (e.g. for two wheels they may be offset diametrically, and for three wheels they may be offset by around 120°, or otherwise not evenly distributed about the circumference).

Advantageously, arranging the at least a subset of the first set of the guide wheels in a circumferentially offset manner provides load bearing mounting, orientation alignment and retention of the transport module to the guide rail.

The guide rail may be a first guide rail, and the transport module may further comprise a second array of guide wheels engageable with a second guide rail, as it may occur in a bi-rail arrangement.

The second array of guide wheels may be described as offset from the first array of guide wheels. Each array of guide wheels may be described as surrounding, or being engageable with, a respective guide rail. Incorporation of a second array of guide wheels, engaging with the second guide rail, reduces the risk of the transport module twisting along the guide rail and increases the load-bearing capacity of the transport module. Described another way, by constraining the guide rail by at least the two arrays of guide wheels, the transport module is more securely constrained, and attached to, the guide rails.

At least one guide wheel may be urgeable into engagement with a respective guide rail by a biasing member.

The biasing member may be a spring or other elastic member. The biasing member may be deformable in the same direction in which the guide wheel is urged (e.g. in the case of a directly mounted biasing member). Alternatively, the biasing member may be deformable in a different direction (e.g. in the case of a pivotally mounted guide wheel).

Advantageously, incorporation of the biasing member compensates for local deformations and/or variations in the dimensions of the guide rail whilst also ensuring the transport module remains securely mounted to the guide rail. The biasing member may otherwise be described as a suspension system. An air, or liquid, based suspension is one example of a biasing member. Alternatively, the biasing member may be an elastomeric (e.g. rubber) block in some embodiments.

At least one guide wheel may be rotatably mounted to a first end of a wheel support, the wheel support may be pivotally mounted about a fulcrum, and a second end of the wheel support may be biased, by the biasing member, such that the at least one guide wheel is urgeable into engagement with the guide rail.

The wheel support may be described as housing at least a part of an axle about which at least one guide wheel rotates. The at least one guide wheel may be described as being fixedly, or rigidly, mounted to the wheel support (e.g. so as to allow the wheel to rotate, but not in a biased manner).

Advantageously, incorporating the pivotally mounted wheel support arrangement reduces the risk of a linearly mounted biasing member clashing with other components (e.g. the inductive power module).

The transport module may have a minor dimension parallel to the guide rail. The motor may define a widest dimension of the transport module in a direction parallel to the guide rail. The transport module may further comprise an elongate support structure, which may be described as a transport module body. The transport module body may be plate-like. The drive wheel may be the only propulsion means of the transport module.

At least a contact surface of the drive wheel, engageable with the guide rail, may be polymeric.

The drive wheel may be of any rotary form used to drive a linear movement. For example, the drive wheel may be a spur, helical spur, pinion (e.g. for engaging a roller rack), sprocket (e.g. for engaging a roller chain), tooth sprocket or a belt-driving wheel.

The drive wheel may be a polymeric drive wheel (e.g. be rubber or an abrasion resistant, load bearing elastomer). The drive wheel may comprise a polymer liner. The drive wheel may be a pinion (e.g. a roller pinion) of a straight or helical rack and pinion arrangement in some embodiments. The rack may be attached to the guide rail.

Advantageously, the use of a polymeric contact surface of the drive wheel has an improved surface life, is compact, relatively quiet an operation and does not require lubrication in comparison to, for example, a metal-on-metal interaction. The need for a lubrication system, and associated costs, can thus be avoided. Furthermore, incorporation of a polymeric contact surface of the drive wheel also facilitates the use of non-machined and/or non-hardened and/or non-ground metal or composite stock in the manufacture of the guide rail(s). Standard, cold-drawn, thick-walled tube, rod or flat steel bar profiles can therefore be used for the guide rails. There are therefore further cost savings attributable to the use of the polymeric contact surface.

The transport module may be described as suspendable from the guide rail by the drive wheel and/or load bearing (typically fixed axle) guide wheels. The transport module may be described as being latched to the guide rail by the drive wheel and/or surrounding guide wheels.

The transport module may further comprise one or more mover-mounted fixtures, mechanical apparatuses and/or powered and controlled electrical devices and/or sensors. The one or more mechanical apparatuses may be connected via gears, sheathed cables or linkages between two or more transport modules and actuated (as known in the art) through variation of the pitch between the two or more interlinked movers. The one or more electrical devices may be connected to and powered via the inductive power module and communicated with via the control module in wireless communication with the central controller. The one or more transport module mounted electrical devices may comprise mini pumps and/or mini compressors, linear and/or rotary actuators, motors, analogue and/or digital sensors, signal converters or energy storage devices etc.

Some of the products moved or transported by the transport module may be acted upon by or between one or more transport modules and/or fixtures, mechanism and/or devices mounted thereon.

In the alternative, or in addition, a mover-mounted device(s) may be for e.g. handling one or more of materials, components, products, packages or other articles. The mover-mounted device(s) may perform functions such as grasping, raising, holding, forming, pressing or otherwise manipulating an item or article in assembly, through a process or manipulation of the process applicator itself, while being carried on and transported by the transport module. The mover-mounted device(s) may interact with primary packaging (e.g. bottles and/or cans). The mover-mounted device(s) may interact with secondary packaging, before, during and/or after package assembly. The mover-mounted devices may comprise one or more sensors. The mover-mounted devices may be described as tooling, or tooling attachments. The mover-mounted devices may be powered via the inductive power module. The mover-mounted devices may be controlled via the control module with process control instruction communicated wirelessly to the control module from the central controller.

The transport module may comprise an energy storage device (e.g. a battery and/or a capacitor) for storing power. The energy storage device may be configured to power or supplement the power and/or stabilize the power to electrical devices mounted on the transport module.

According to a second aspect of the invention there is provided a product transport system, the product transport system comprising:
a first transport module as described anywhere herein;
a guide rail; and
   a power supply rail;
wherein the first transport module is mounted to, and movable along, the guide rail; and
wherein the power module is configured to receive electrical power contactlessly from the power supply rail.

The product transport system may be for a production line, such as a beverage production line. The product transport system may be referred to as a product handling system.

The guide rail may be an open or a closed loop. The guide rail may be manufactured from a material in a state which the material is received from a supplier. For example, where the guide rail is metallic (e.g. a metal or alloy), the material may not require any hardening (or similar) process and/or machining. Described another way, the guide rail may be manufactured from e.g. non-hardened metallic materials (e.g. non-hardened steel) and applied in the form and with the surface finish as supplied. Alternatively, the guide rail may be manufactured from a given material, cross section profile and surface finish and optionally surface hardened or toughened and/or the surface texture modified by a number of post fabrication processes known in the art. The means of propulsion and guide wheel arrangements of the transport module furthermore take up (accommodate) moderate degrees of section deformation as which will occur when, especially tubular, sections are shaped or rolled into corners or bends etc. The guide rail may alternatively be manufactured from composite materials, where similar advantages are also realised (i.e. reduced machining requirements, resulting in lower costs).

In comparison to existing solutions, the product transport system provides high capacity, significant flexibility, improved speed, scalability, is modular, and cost efficient. It enables flawless 3-dimensional routing and constant system power and performance independent of that routing which may comprise complex corners, corkscrews, barrel rolls, inversions, spirals (up/down), ±y & ±z axis bends, clothoids, various radii, changing radii, splitters, mergers, switches, and the like.

The product transport system may comprise a control system. The control system may comprise a master controller in electrical communication with a bi-directional wireless transmitter. The wireless transmitter may be configured to transmit a control signal to the bi-directional wireless receiver of the transport module mounted control module and receive status and event feedback signals back from the control module.

The control system may comprise a communication system, which may be characterized as being one or more bi-directional, low latency, low jitter, deterministic, wireless machine automation communication systems. The control system may include a central machine controller (e.g. PLC (Programmable Logic Controller) or IPC (Industrial Process Controller) configured to communicate with one or more control modules located on the transport modules via the wireless communication system.

The product transport system may further comprise a second transport module according to the first aspect of invention.

The first and second transport modules may be identical to one another. Alternatively, the first and second transport modules may differ from one another. In preferred arrangements, the transport modules are arranged in an alternating manner so as to be able to reduce the effective pitch between adjacent transport modules (e.g. separation between respective centrelines). The first and second transport modules may be nestable with one another (e.g. may generally ‘fit’ together, to realize a reduced pitch, while accommodating elements per transport module which are greater in size (e.g. diameter) than the resulting pitch (e.g. drive wheel, spur pinion, roller pinion)).

The first and second transport modules may be independently controllable. The first and second transport modules may operate along the common support rail at variable pitch and velocity along or about the track (rail).

A pitch, or separation, between the transport modules may therefore be adjustable. The product transport system may be described as a variable pitch and pace system owing to the independently controllable nature of the transport modules. Adjusting the pitch, or separation, between transport modules is desirable for improving the flexibility of the product transport system. For example, for a comparatively slow-moving part of the system it may be desirable to provide the transport modules relatively close to one another (e.g. low pitch) whereas for other parts of a system, which are comparatively faster moving, it may be desirable to provide the transport modules with the comparatively greater pitch (e.g. greater separation). It is advantageous to be able to vary the pitch between adjacent transport modules at, for example, individual process steps and/or between lines. It is also advantageous to be able to vary the pitch as the product increases or decreases in size while moving through various workstations along the system (e.g. some products may increase in size as constituent items are added, whilst packaging may spatially decrease in size as cardboard blanks are erected). It may also be advantageous to operate two or more transportation modules in collaborative sets at variable velocity but in constant or controlled distance (pitch) between each other.

For example, the pitch between the first and second transport modules may be less than 55 mm while the drive wheel or pinion may be less than 110 mm.

The pitch is defined as the separation between centrelines of adjacent transport modules. A pitch between the first and second transport modules may be less than around 54 mm.

The pitch being less than around 54 mm is desirable because, in the case of a beverage production line; a typical can diameter is around 54 mm. By having an effective pitch of the transport modules less than the width (e.g. diameter) of e.g. a (sleek) beverage can, the transport modules can be located adjacent to one another even when a mover-mounted device has the can gripped for example.

The guide rail may be a first guide rail, the system may further comprise a second guide rail, wherein the drive wheel of the first transport module may be engageable with the first guide rail, and wherein the drive wheel of the second transport module may be engageable with the second guide rail.

The rotary drive motor of the first transport module may be mounted at a first end of the first transport module. The rotary drive motor of the second transport module may be mounted at a second end of the second transport module.

The power transmission of the first transport module being engageable with the first guide rail, and the power transmission of a second transport module being engageable with a second guide rail, may be described as an alternating arrangement of transport modules. Advantageously, this arrangement facilitates the nestability of adjacent transport modules or, described another way, facilitates the reduction of a pitch between adjacent transport modules. This is desirable for reasons of being able to incorporate more transport modules on a given length of guide rail, and so being able to carry out more operations for a given length of guide rail. Furthermore, a comparatively larger diameter drive wheel, spur pinion or roller pinion can be used whilst maintaining a comparatively low pitch (e.g. less than around 53 mm in preferred embodiments).

The guide rail may define a complex path.

Complex path is intended to mean that the guide rail extends in a non-planar manner. For example, the guide rail may comprise three-dimensional geometries such as, but not limited to: curved inclines and/or declines (e.g. banked corners) and helical portions (e.g. corkscrews, spirals, barrel rolls) etc. The guide rail may extend and/or include curves in all three-dimensions (e.g. about the x, y and z axis)—for example rather than being limited to a single dimension or a two-dimensional plane. This may allow for left, right, up, down corners and corners of various constant and/or varying radii, clothoids, chambered corners, corkscrew, barrel role, spiral up or down curves, and again all at constant or varying radius and/or rates of three dimensional change in curvature. This is in contrast to planar paths which nevertheless may have complex routes up to a certain degree; but typically cannot handle high level complexity in terms of a multitude of dimensions with various and multiple straights, radii and clothoids therein, as is achievable by the totally flexible, customizable and profiling 3-dimensionality of the product transport system according to the present invention. In certain embodiments, a complex path may require a certain degree of non-planarity, e.g. a complex path may include corners with a radius of curvature of less than 5 m, 3 m, 2 m, 1 m or 0.5 m

Advantageously, the guide rail defining a complex path means that the product transport system can incorporate a guide rail having a wider variety of geometries than existing solutions. The combination of features provided in the transport module facilitates the guide rail having a complex path whilst still providing a reliable product transport system.

Specific embodiments of the present invention will now be described, by way of example only, with reference to the accompanying drawings in which:

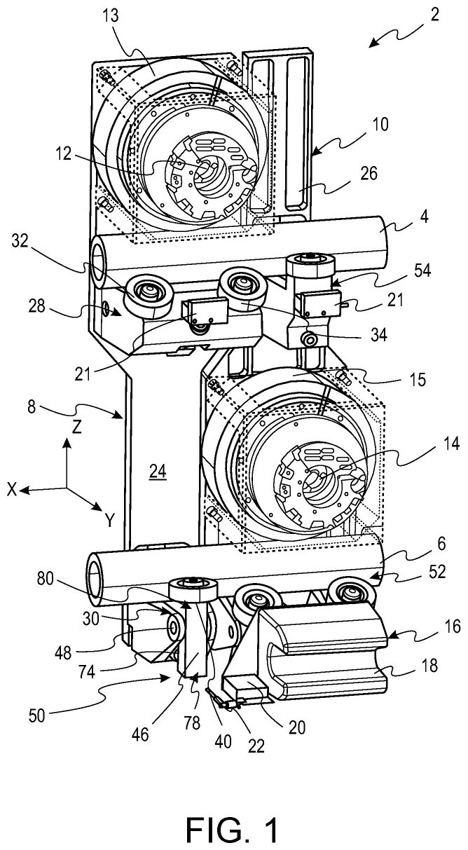

FIG. 1 is a first perspective view (rail side, semi-transparent) of a product transport system according to an embodiment;

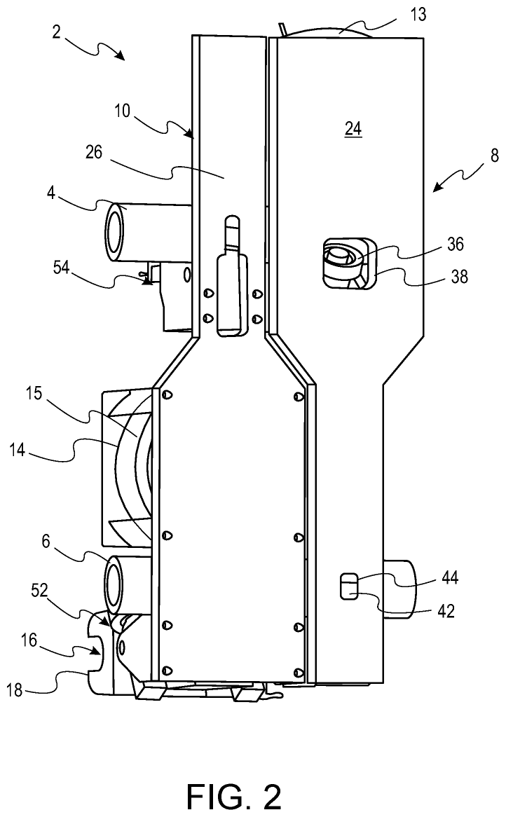

FIG. 2 is a second perspective view (transport module (front) side) of the product transport system of FIG. 1;

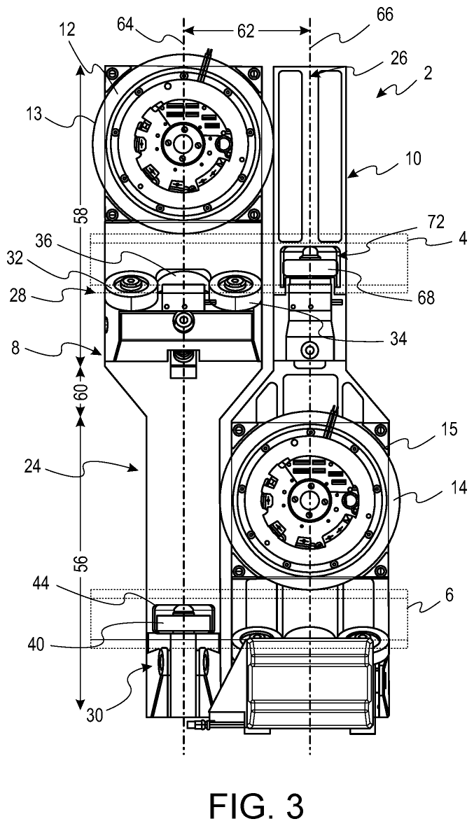

FIG. 3 is a line drawing, showing the product transport system of FIGS. 1 and 2 from the rail side (rear);

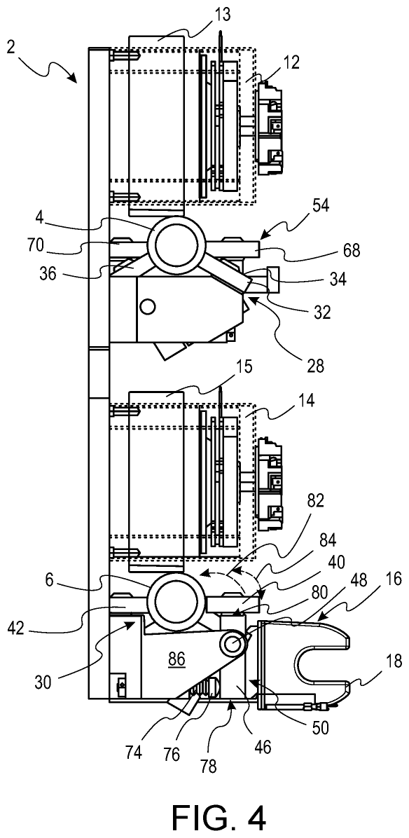

FIG. 4 is a right hand side (end) view line drawing of the transport system of FIGS. 1 to 3 taken normal to the guide rails;

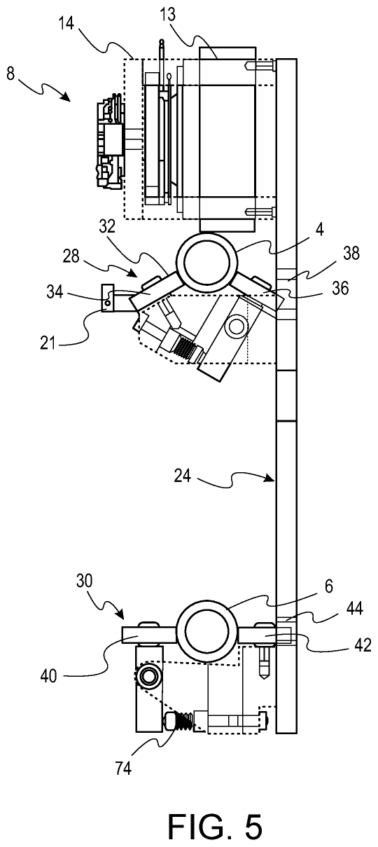

FIG. 5 is a left hand side (end) view of the first transport module of the system of FIGS. 1 to 4 in isolation, with first and second guide rails also visible;

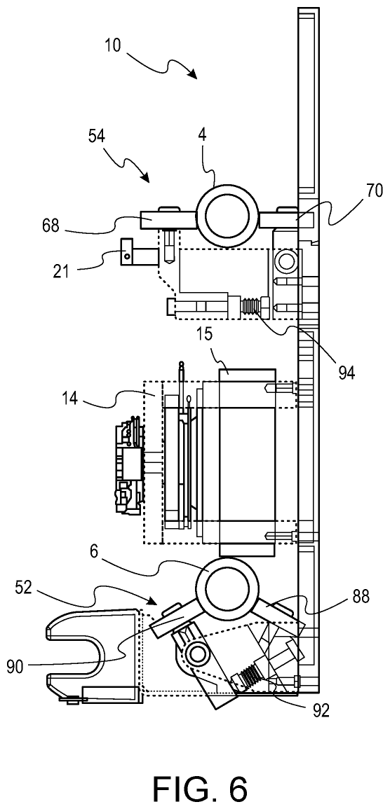

FIG. 6 is a left hand side (end) view of the second transport module of FIGS. 1 to 4 in isolation, with first and second guide rails visible;

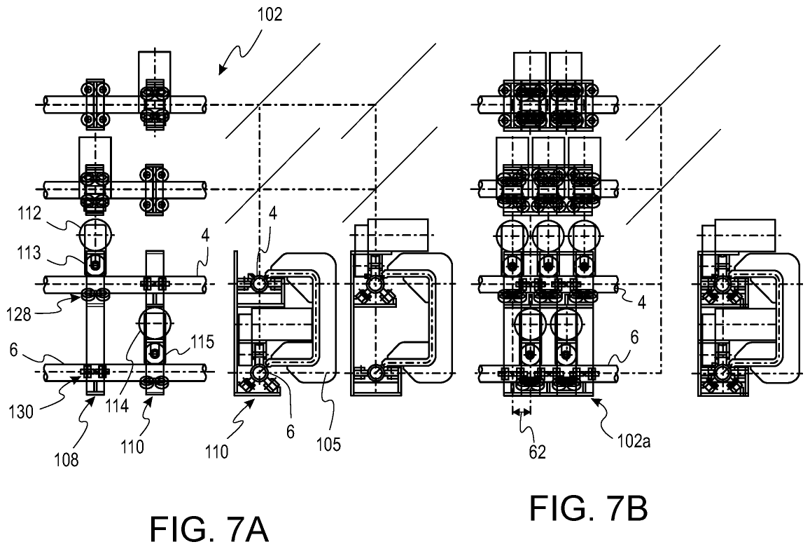

FIG. 7A shows in another embodiment, third angle orthographic projections of a top and separately of a bottom rail driven transportation module while FIG. 7B shows a set of the said upper and lower rail driven transportation modules nested together as a group at minimum pitch;

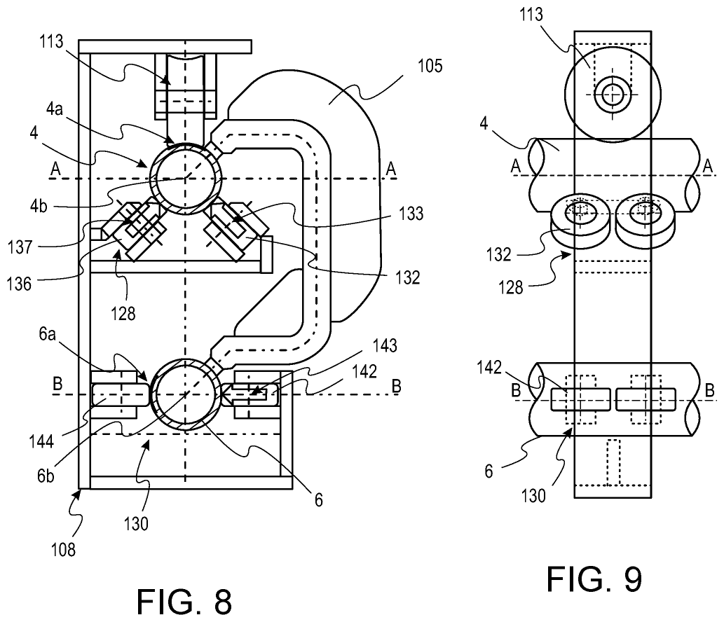

FIG. 8 is a magnified right hand (end) view of the FIG. 7A third angle orthographic projection;

FIG. 9 is a magnified rear (rail side) view of the FIG. 7A third angle orthographic projection;

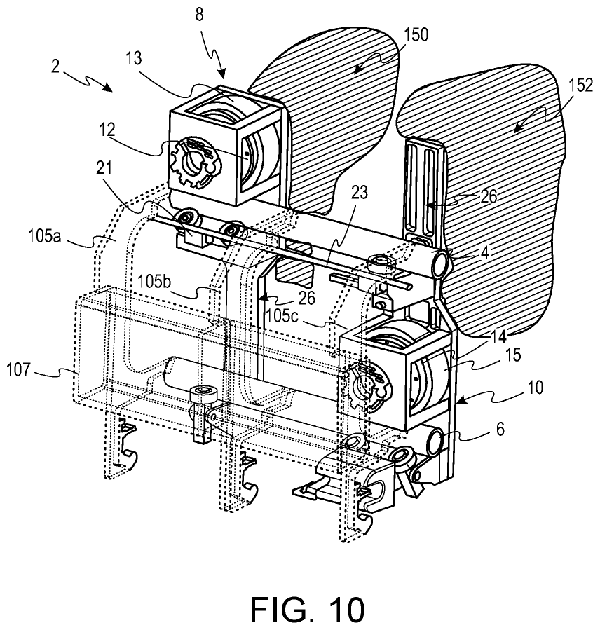

FIG. 10 is a perspective view of the product transport system of FIGS. 1 to 4 with mover-mounted devices schematically depicted;

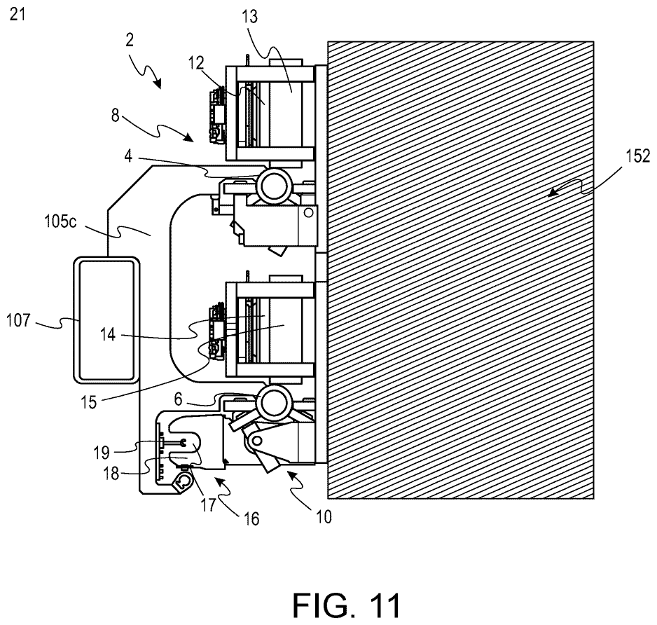

FIG. 11 is a left hand side (end) view of a nested pair of transport modules; and

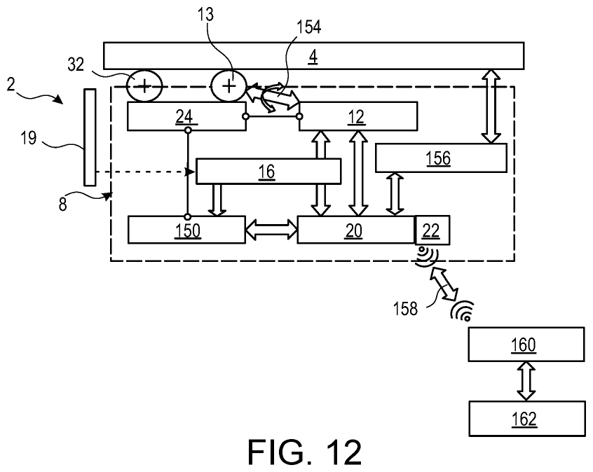

FIG. 12 is a schematic example of a control system for the transport system.

FIG. 1 is a perspective view of a product transport system 2 according to an embodiment of the present invention. FIG. 1 shows the product transport system 2 from the rail side, and may therefore be referred to as a rear view. FIG. 1 illustrates the x, y, z cartesian coordinate system used herein.

The product transport system 2 comprises first and second guide rails 4, 6. Although the first and second guide rails 4, 6 are shown as being relatively short in axial extent, it will be appreciated that the first and second guide rails 4, 6 may extend to any desirable length and may define a curvilinear route while always being of fixed pitch relative to one another. The product transport system 2 may be described as a bi-rail system, owing to the presence of first and second guide rails 4, 6 only, but it will be appreciated that other embodiments may be monorail, tri-rail, quad rail (of diamond, square, rectangle, trapezium, frustum & other geometrical rail positions (as appreciated in cross section) etc. having varying number, pattern, shape and/or cross sectional size (or combination thereof) of guide rails.

The product transport system 2 further comprises (although is not limited to) first and second transport modules 8, 10. Each of the transport modules 8, 10 are mountable to the guide rails 4, 6. Although not shown in FIGS. 1 and 2, each of the transport modules 8, 10 may further comprise a mover-mounted bracket, sensor or powered and controlled device, e.g. a jig, a limit switch or pressure sensor, an actuator, for handling products or other payloads as described herein. The functionality of the transport modules 8, 10 therefore includes facilitating movement of the mover-mounted devices, and so any products which the devices interact with, along the guide rails 4, 6. The transport modules 8, 10 may be used to transport products between different stations of a production line, for example, and may even be used to transport products between different buildings.

Turning to describe the features of the transport modules 8, 10 in more detail, each of the transport modules 8, 10 comprises a rotary drive motor 12, 14 in torque communication with a drive wheel 13, 15. The rotary drive motors 12, 14 facilitate the independent and self-propelled functionality of each of the transport modules 8, 10. The rotary drive motors 12, 14 may be directly connected to a respective drive wheel 13, 15, or may be connected to a respective drive wheel via a transmission (for example). The transmission may be in-hub (e.g. cycloid) or external to the hub (e.g. hypoid). The rotary drive motors 12, 14 may incorporate built-in brakes so as to maintain the position of the transport modules 8, 10 on vertical and/or inclined guide rail sections or when anywhere stationary during system stoppages and/or power outages, or when a motion profile so dictates.

Advantageously, providing a rotary drive motor as opposed to, for example, a linear motor, relaxes the tolerance requirements placed on the rails (e.g. the tolerance constraints between an effective rotor and stator are limited to the rotary motor itself, rather than between a drive wheel and the guide rail). The constraints between the drive wheel and guide rail are also met locally by bearings, as opposed to along an entire length of the guide rail (as needed for linear motor systems). The use of rotary drive motors 12, 14 is also advantageous in that motive power and precision of the transport modules 8, 10 can be maintained irrespective of the geometry of the guide rails 4, 6 (e.g. across straights, curves, so on). More space is also available, proximate the guide rails 4, 6, in comparison to, for example, a linear motor system, for locating mover-mounted devices. Rotary drive motors 12, 14 are also comparatively easier to cool than, for example, linear drive systems which may have complex and costly cooling requirements. The rotary drive motors 12, 14 may be cooled as the transport modules 8, 10 travel along the rails 4, 6. The need for a (liquid) cooling system, and associated costs, can thus be avoided. Rotary drive motors 12, 14 also require less frequent, and less complex, maintenance. There is also far greater choice of component suppliers, and component choice generally, available for rotary drive motors, and other associated components (e.g. drive wheels, transmission etc.) in comparison to, for example, linear drive systems. Rotary drive motors can also be more readily scaled (e.g. in terms of power output) for the application in question in comparison to, for example, linear drive systems.

Although only shown in connection with the second transport module 10, each transport module 8, 10 further comprises an inductive power module 16. The inductive power module 16 is used to independently power the respective transport module 8, 10. Power is provided in a contactless manner as a conductor 18, forming part of the inductive power module 16, transverses a power supply rail (not visible in FIG. 1 or 2 but labelled 19 in FIG. 11). Advantageously, the inductive power module 16 provides an uninterrupted, and contactless, power supply without the associated disadvantages of a contact power transfer system (e.g. a shoe which contacts a bus bar) which can wear over time and be liable to interruptions due to debris and/or other contamination.

Each transport module 8, 10 further comprises a control module 20 (only shown in connection with the second transport module 10 in FIG. 1). The control module 20 is electrically connected to the rotary drive motor 14 in the illustrated embodiment, but may communicate with the rotary drive motor 14 wirelessly in other embodiments. The control module 20 comprises a wireless receiver 22, which may be referred to as a wireless client, which is configured to receive a control signal from a master controller (not shown in FIG. 1 or 2 but labelled 162 in FIG. 12). The control signal may be received from a radiating cable antenna laid parallel to the path of the guide rails 4, 6, which forms part of the bi-directional wireless communication system.

The incorporation of the rotary drive motor 14, inductive power module 16 and control module 22 (specifically the wireless receiver 22 thereof) means that the transport module 10 is both untethered (i.e. is not connected to any wires, hoses or the like which extend from a stationary object) and is entirely independently controllable of any surrounding transport modules. The transport modules 8, 10 are therefore independently controlled and self-propelled units.

For completeness, each of the transport modules 8, 10 comprises an elongate support structure which may be referred to a transport module body 24, 26 respectively. The transport module bodies 24, 26 provide a mount to which all of the other constituent components can be attached. In the illustrated embodiments the transport modules bodies 24, 26, take the form of plates which have a variable width along their height (e.g. see narrow portion 56, transition zone 60 and thickened portion 58 in FIG. 3). Specifically for small pitch applications, adjacent module bodies 24, 26, and so transport modules 8, 10 more generally, may be configured to be nestable with one another, as shown in FIGS. 1 and 2, such that adjacent transport modules 8, 10 can be located in closer proximity to one another than if the transport module bodies 24, 26 were, for example, entirely rectangular. The use of nestable transport modules is one example arrangement of a transport system. Other examples may include non-nestable (e.g. identical) transport modules.

The nestability of adjacent transport modules 8, 10 is also aided by the fact that drive wheels associated with respective rotary drive motors 12, 14 are engageable with different guide rails 4, 6. Put another way, the first transport module 8 has a drive wheel which is engageable with the first, upper guide rail 4, whilst the adjacent second transport module 10 has a drive wheel which is engageable with the second, lower guide rail 6. By locating the drive motors 12, 14 in a thickened portion of the transport module bodies 24, 26, and alternating the orientation of the adjacent transport module bodies 24, 26, the nestability of adjacent transport modules 8, 10 is improved (e.g. potential clashes between adjacent rotary drive motors 12, 14 can be avoided).

Each of the transport modules 8, 10 further comprises two arrays of guide wheels: a first array of guide wheels and a second array of guide wheels respectively. Beginning with the first transport module 8, the first transport module 8 comprises a first array of guide wheels 28 and a second array of guide wheels 30. As suggested by the name, the arrays of guide wheels 28, 30 each comprise a plurality of individual guide wheels. The guide wheels may be described as passive (i.e. not driven) wheels. The purpose of the guide wheels is to compensate for any dimensional and/or geometric variation in the cross sections of the guide rails 4, 6 respectively, and also any variation between the guide rails 4, 6. Having guide wheels with limited travel can also prevent inadvertent separation of the transport module from the guide rail.

The first array of guide wheels 28 comprises three guide wheels 32, 34, 36 (although in other examples the number of guide wheels may be more or less than three). The guide wheel 36 is not visible in FIG. 1 but is visible through a cut-out 38 in FIG. 2. The first array of guide wheels 28 surrounds the first guide rail 4, the first guide rail 4 being the rail which is engageable by the drive wheel of the first transport module 8. The individual guide wheels 32, 34, 36 which make up the first array 28 are also observed to be circumferentially offset with respect of the drive wheel. Described another way, the constituent guide wheels are provided at different circumferential positions around the guide rail 4. This layout of wheels provides for a more secure retention of the transport module 8 on the guide rail 4 in use. The guide wheels 32, 34, 36 collectively act to centre the transport module in the y-z plane and prohibit vertical up movement in the z-axis. As will be described in detail later in this document, the rear guide wheel 36 is also urgeable into engagement with the first guide rail 4 by a biasing member (e.g. a suspension system is present).

Each of the constituent guide wheels 32, 34, 36 also comprises at least a polymeric contact surface (e.g. the surface of the wheel which engages the guide rail 4). Examples of the polymeric material may include polyurethane (e.g. CC Nylex™ or Vulkollan™)

Turning to consider the second array of guide wheels 30, unlike the generally triangular arrangement (e.g. circumferential distribution) of the first array of guide wheels 28 with respect to the drive wheel 13, the second array of guide wheels 30 comprises only two constituent wheels 40, 42 which are diametrically opposed about the second guide rail 6. The second array of guide wheels 30 primarily act to prevent rotation of the transport module about the first guide rail 4—e.g. resisting rotation due to a cantilevered weight on the transport module. The second array of guide wheels 30 are also arranged to allow vertical movement in the z-axis, thus accommodating for variation in spacing of the two guide rails 4, 6. A rear guide wheel 42 is again hidden from view in FIG. 1 but is shown through a cut-out 44 in FIG. 2. Like the guide wheel 36 described in connection with the first array 28, the guide wheel 40 is also urgeable into engagement with the second guide rail 6 by a biasing member 74 (more clearly visible in FIG. 4). Specifically, the guide wheel 40 is rotatably mounted to a first end 80 of a wheel support 46. The wheel support 46 is pivotally mounted about a fulcrum, or pivot, 48. The second end of the wheel support 46 bias, by the biasing member 74 such that the guide wheel 40 is urged into engagement with the second guide rail 6. The combination of the wheel support 46, fulcrum 48 and biasing member 74 may be referred to as a biasing arrangement.

Although not described here for reasons of brevity, from FIGS. 1 and 2 it will also be appreciated that the second transport module 10 also comprises a first array of guide wheels 52, the constituent guide wheels being engageable with the second guide rail 6. The second transport module 10 further comprises a second array of guide wheels 54, the constituent wheels being engageable with the first guide rail 4.

Of note, whilst in FIGS. 1 and 2 the cross section of the first and second guide rails 4, 6 is generally annular (e.g. that of a hollow cylinder), it will be appreciated that other geometries of guide rail are otherwise possible. Specifically, a profile of the rails 4, 6 can be adjusted (in both dimensions and geometry) to suit the application in question (e.g. by adjusting the number of rails (e.g. two, three, four, or more), the depth of rails, width of rail, to provide a high second moment of area) and/or the spacing of the rails.

Furthermore, an advantage of the transport modules 8, 10 is that the tolerance requirements and surface finish requirements placed on the guide rails 4, 6 can be relaxed in comparison to, for example, prior art linear motor systems. Existing systems may require very precise tolerances; hardened and precision ground surface finishes; strong, machined mounting structures and precision alignment of joints; all of which contribute to a very high cost per metre. Furthermore, the high precision of linear motor systems may not be necessary in certain environments (e.g. in bottling, packaging and transport operations). It will also be appreciated that the guide rails may be formed with a number of different constituent pieces, and possibly from varying materials along the length of the system.

The use of the transport modules 8, 10 also provides greater flexibility in the geometry of the track which can be defined by the guide rails 4, 6. The guide rails 4, 6 can define a curvilinear form. The guide rails 4, 6 may define a complex path with curves in all three dimensions, or two perpendicular planes. For example, the path, or routing, of the guide rails can be more readily customised, as well as greater variation in the size of any bend radii or varying radii being possible. Furthermore, complex features such as clothoid curves (phased in/out angular acceleration), banked (cambered) curves, corkscrews (CW/CCW), spirals (up/down) incline/declines ramps, diversion and merge junctions can be incorporated. Such features cannot be easily incorporated in a linear motor system owing to limitations associated with such systems. Greater flexibility in track geometry (e.g. guide rail geometry) is also desirable for the reason that a warehouse or other building volume, for example, can be used more effectively (e.g. including, for example, elevated operations such as overhead transfers). Continuous motion of the transport modules 8, 10 can also be realised.

Further applications of the transport modules 8, 10, and product transport system 2 more generally, include:
Manufacturing and transportation operations in vertical operations such as primary container manufacture;
Packaging material supply (transportation) from materials warehouse through to packaging lines;
Dunnage (e.g. padding material) removal (transportation) from packaging lines to e.g. compacting ahead of recycling;
Primary product container handling through processes and/or transportation (empty or filled);
Secondary packaging handling through processes and/or transportation; and/or
Tertiary packaging handling through processes and/or transportation.

The transport modules 8, 10, and product transport system 2 generally, are particularly well suited to the fast moving consumer goods (FMCG) industry, including beverages specifically. The transport modules 8, 10, and product transport system 2 generally, are also suited to assembly lines.

In comparison to existing solutions, the product transport system 2 provides high capacity, significant flexibility, improved speed and desirable scalability, and is modular. Specifically, capacity and scalability is achieved by incorporating more transport modules and/or adding further transport module mounted powered and controlled devices (sensors and toolings (motors, pumps (pressure/vacuum), actuators, solenoids, suction cups etc). Significant flexibility of design is realised because of the reduced constraints placed on the guide rails. For example, material choices, geometries, surface finishes etc. are more freely adjustable than in linear motor systems (where these parameters are heavily constrained). Speed is entirely adjustable, by way of the independently controllable transport modules, and can be increased by incorporation of a more powerful rotary drive motor if needed. The product transport system 2 is also entirely modular in that, as mentioned, further transport modules can be incorporated as well as additional lengths of guide rails being used.

Turning to FIG. 3, a view of the system 2 from a rail-facing side is provided. FIG. 3 shows the first and second transport modules 8, 10 with respective drive motors 12, 14 and various other components described in connection with FIGS. 1 and 2.

FIG. 3 illustrates the transport module body 24 having a narrow portion 56 and a thickened portion 58, with a transition zone 60 extending therebetween. The nesting of the first and second transport modules 8, 10 is also more clearly illustrated in FIG. 3, attributable due to the alternating arrangement of the narrow and thick portions of the respective transport bodies 24, 26.

From FIG. 3 it will also be appreciated that a diameter of the rotary drive motor 12 is slightly wider than an associated thickness of the thickened portion 58 of the first transport body 24. As previously described, by effectively alternating the positions of the rotary drive motors 12, 14, of the first and second transport modules 8, 10 respectively, the pitch 62 between the transport modules 8, 10 can be reduced. In preferred embodiments this pitch is less than around 54 mm. For completeness, the pitch 62 is defined as the distance, in a direction along the guide rails 4, 6, between respective centrelines 64, 66 of the first and second transport modules 8, 10.

Turning to FIG. 4, a side view of the system 2 is provided from a left-hand side of the FIG. 3 view (e.g. looking at the system 2 from the first transport module 8 side). Most of the visible components have been described in detail previously, although a cross section of the conductor 18 of the inductive power module 16 is visible in FIG. 4. The conductor 8 has a generally U or C-shaped cross section in which the power supply rail is receivable, contactless, in use (see also FIG. 11).

FIG. 4 also shows the distribution (e.g. circumferential/diametric) of guide wheels which make up the first and second arrays of guide wheels associated with each of the first and second transport modules 8, 10 respectively. Specifically, diametrically opposed guide wheels 40, 42 of the second array of guide wheels 30 of the first transport module 8 are visible at the lower end of FIG. 4. Guide wheels 32, 36, forming part of the first array of guide wheels 28 of the first transport module 8, are also shown circumferentially distributed about the first guide rail 4. Finally, diametrically opposed guide wheels 68, 70 of a second array of guide wheels 54 of the second transport module 10 are also visible.

Also shown in FIG. 4 is the biasing arrangement 50 of which the guide wheel 40 of the second array of guide wheels 30 of the first transport module 8 forms part. In FIG. 4 the biasing member 74 of the biasing arrangement 50 is visible. The biasing member 74 takes the form of a spring, the biasing member 74 having an end cap 76 which engages wheel support 46. Specifically, the biasing member 74, and more specifically the end cap 76 thereof, engages the second end 78 of the wheel support 46. The guide wheel 40 is rotatably mounted to the first end 80 of the wheel support 46. Owing to the wheel support 46 being pivotally connected about the fulcrum 48, the biasing member 74 urges the guide wheel 40 into engagement with the second guide rail 6 in a direction labelled 82. The wheel support 46, and so the guide wheel 40, can pivot in the direction labelled 84 (e.g. when not under the bias of the biasing member 74). As shown in FIG. 4, the fulcrum 48 is defined in a mount 86. The guide wheel 40 is rotatably mounted to the mount 86, although this is in a fixed, and not biased, manner. Guide wheel 40 is an example of a floating axle guide wheel. The floating axle guide wheel 40 (and corresponding floating axle guide wheels in the other guide wheel arrays) are configured to accommodate diametrical, surface and geometrical variations in the cross-section of rail while the mover is latched to the top rail.

Turning to FIG. 5, a front view of the first transport module 8 (driven on the top rail) in isolation, with the first and second guide rails 4, 6 also viable, is provided. FIG. 6 is a front view of the second transport module 10 (driven on the bottom rail) in isolation, also with first and second guide rails 4, 6 visible.

Beginning with FIG. 5, FIG. 5 shows the biased nature of some of (e.g. a subset of) the guide wheels (i.e. the floating axle guide wheels) in more detail owing to partially cutaway views of the surrounding components. Beginning with the first array of guide wheels 28, the guide wheel 34 is shown unbiased. That is to say, the guide wheel 34 is rotatably mounted in place such that it is free to spin (e.g. rotate) about an axis, but that axis cannot be linearly, or arcuately, displaced. This may be described as a rigid (fixed axle) wheel mounting. With loads hung and application forces applied off the transport module body 24, the fixed axle drive wheel 13 and fixed axle guide wheels (32, 34) are the principal load bearing rolling members of the first wheel array. Wheel 36 is a sprung, suspension mounted guide wheel that compensates for minor rail cross-sectional shape, dimension and surface irregularity variations. Guide wheel 36 may be pre-tensioned via (e.g.) one or more high spring constant springs (e.g. leaf, coil, torsion, disc, poly-wave disc) or torsion bars or combination, or equivalent, thereof. The suspension travel of sprung guide wheels is limited to be adequate to accommodate the aforementioned rail deviations, to always ensure the transport module is attached to the rail and that should a negative moment occur (e.g. due to excessive tooling and/or process forces), that transport module rotation about the x-axis is very limited (minimal). In contrast, the guide wheel 36 is biased in a pivotally mounted manner like that described earlier in this document.

The lower portion of FIG. 5 also shows the second array of guide wheels 30 comprising the guide wheels 40, 42. The guide wheel 40 is a floating axle guide wheel, urgeable into engagement with the second guide rail 6 by the biasing member 74. The travel of guide wheel 40 is adequate to accommodate the aforementioned rail deviations, but limited such that should a negative moment occur (e.g. due to excessive tooling and/or process forces), rotation about the x-axis of the transport module is limited.

As described above, the guide wheel 42 is rotatably mounted and is not biased—i.e. it is a fixed axle guide wheel. This fixed axle guide wheel is primarily a load bearing guide wheel configured to resist rotation of the transport module 8 about the x-axis.

FIG. 5 also shows the guide wheels 36, 42 projecting into respective cut-outs 38, 44 in the transport module body 24.

Turning to FIG. 6, it will be appreciated that, of the first array of guide wheels 52 (lower rail in this bi-rail configuration and orientation), the guide wheel 88 is only rotatably mounted and is a fixed axle guide wheel 88. A guide wheel 90 is pivotally mounted and biased by biasing member 92 and is therefore a floating axle guide wheel 90. Guide wheel 88 is a fixed axle guide wheel.

The drive wheel 15 supports the transport module 10 in the z-axis. The first array of guide wheels 52 act to centre the transport module in the y-z axis. The fixed axle guide wheel 88 is primarily a load-bearing guide wheel and the sprung action of guide wheel 90 compensates for diametrical, surface and geometrical variations in the cross-section of rail.

FIG. 6 also indicates that, of the second array of guide wheels 54, the guide wheel 68 is only rotatably mounted (fixed axle) whilst the guide wheel 70 is pivotally mounted and biased by biasing member 94.

The second array of guide wheels 54 act to resist rotation of the transport module 10 about the x-axis. Fixed axle guide wheel 68 is primarily a load-bearing guide wheel, while floating axle guide wheel 70 acts to compensates for diametrical, surface and geometrical variations in the cross-section of rail. The combination of two guide wheel arrays may act to permit load bearing travel along the rail while prohibiting unwanted translation along the y & z axes and prohibiting unwanted rotation about the x, y, z axes. The above is performed, permitting the Mover to navigate the 3-dimensional constant, varying, start and finish curvatures of the curvilinear rail system while holding the Mover in a suitably controlled, constrained and aligned manned, all the while accommodating rail member cross-section dimensional, geometrical and surface variations relative to the datum faces thereof and to variations in the pitch of the multi-rail system.

When considering FIGS. 5 and 6 in combination, it will be appreciated that it is preferable at least one guide wheel of each array of guide wheels is urged into contact with the respective guide rail by a biasing member. It is also preferable that at least one other guide wheel of that array be rotatably mounted without being biased (e.g. be fixedly mounted, but free to spin). Furthermore, it is preferable that guide wheels of the first array (e.g. proximate the respective rotary drive motor 12, 14) are circumferentially offset from the drive wheel in a non-diametric manner. It is also preferable that the guide wheels of the second array are diametrically offset from one another.

Turning to FIGS. 7A and 7B, a number of third angle 2D projections of a product transport system 102 according to another embodiment are provided. For completeness, the product transport system 102 shares many features in common with the product transport system 2 of the preceding Figures and will therefore only be briefly described.

Like the product transport system 2, the product transport system 102 comprises first and second transport modules 108, 110 and first and second guide rails 4, 6. FIGS. 7A and 7B also show part of a C-shaped support structure 105 to which the first and second guide rails 4, 6 are mounted.

As will be appreciated from the construction lines included in FIGS. 7A and 7B, FIG. 7A shows a number of third angle projections of Transport Modules 108 and 110 on a tubular curvilinear bi-rail. For example, on the left-hand side of FIG. 7, a transparent front elevation is shown with one top rail driven transport module 108 and one bottom rail driven transport module 110, spaced apart on a tubular bi-rail horizontally oriented with one tube vertically above the other (i.e. transport modules with vertical module face plates on a horizontal track). Relative to the front elevation described above, FIG. 7A shows, in third Angle Orthographic projection, side views of transport module 108 and separately of transport module 110 and top rail vs bottom rail drive and guide wheel arrangements of modules 108 and 110.

In FIG. 7B, transparent front elevations are shown with three top rail driven transport modules in close pitch of two bottom rail driven modules, on a tubular bi-rail horizontally oriented with one tube vertically above the other (i.e. modules with vertical face plates on a horizontal track). Relative to the front elevation, in third angle orthographic projection, shows the combined end view of the nested transport modules and top rail vs bottom rail drive and guide wheel arrangements of the nested transport modules.

FIGS. 7A and 7B, in combination with close up view FIGS. 8 and 9, illustrate further detail of the arrangement of guide wheels around the first and second guide rails 4, 6 respectively as associated with each of the first and second transport modules 108, 110. Specifically, and described in connection with the first transport module 108 in detail only, the drive wheel 113 is engageable with a first (datum) face 4a of the first guide rail 4. The (datum) face 4a is intended to refer to a face of the guide rail 4 which is engaged by a wheel, drive wheel or guide wheel, which is not biased.

A first array of guide wheels 128 is circumferentially distributed around the first guide rail 4 with respect to the drive wheel 113, the first array of guide rails 128, comprising guide wheels 132, 136, is provided proximate the rotary drive motor 112 and acting to latch the transport module in the y-z plane and about z and y axis rotation. In the illustrated embodiment both of the guide wheels 132, 136 are biased into engagement with the first guide rail 4 in a direction indicated by arrows 133, 137.

A second array of guide wheels 130, comprising guide wheels 142 and 144, are diametrically opposed about the second guide rail 6 and act to resist x-axis rotation of the transport module. Guide wheel 144, distal the C shaped support structure 105 is rotatably mounted and rigidly engages the second guide rail 6, specifically a (datum) face 6a thereof. Diametrically disposed across a centreline 6b of the second guide rail 6 is the other guide wheel 142. The guide wheel 142 is biased into engagement with the second guide rail 6 in a direction indicated by arrow 143. The second array of guide wheels 130 acting on rail 6, are located distal to the drive wheel 113 and associated first array guide wheels 128, acting on rail 4. This is also true for the second transport module 110, although the drive wheel 115 is engageable with the second guide rail 6 (and an associated first array of guide wheels is thus distributed about the second guide rail 6).

Turning to the right-hand side of FIG. 7, the view labelled 102a shows the system 102 comprising a total of five transport modules, all arranged adjacent one another on the first and second guide rails 4, 6. These views show how the pitch 62 between adjacent transport modules can be reduced owing to the alternating position of respective rotary drive motors. The reduced pitch facilitates the incorporation of more transport modules on a given length of guide rail, which is advantageous for being able to carry out more operations on a given length of guide rail (e.g. contributes to the scalability and flexibility of the system 102). In preferred arrangements the pitch is less than 54 mm, permitting the handling and grouping of e.g. individual primary containers, with one container gripped and transported and/or manipulated per transport module. Like the previous product transport system 2, in comparison to existing solutions, the product transport system 102 provides high capacity, significant flexibility, improved speed and desirable scalability, as well as being modular in nature.

Turning to FIG. 10, a perspective view of a modified embodiment of the system 2 shown in FIGS. 1 to 4 is provided.

As previously discussed, and so not repeated here for brevity, the system 2 comprises first and second transport modules 8, 10 mounted to and traversable along first and second guide rails 4, 6. The first and second guide rails 4, 6 are mounted to a plurality of support structures 105a-c which, in the illustrated embodiment, are generally C shaped or otherwise configured and attached to the rails providing the necessary support while allowing unobstructed passage of the Movers along the curvilinear rail (e.g. tubular bi-rail in the example). By way of example, each of the plurality of C-shaped support structures 105a-c is mounted to a beam 107. The combination of the beam 107 and C-shaped support structures 105a-c provides a desirable lightweight, robust and low cost support frame with appropriate bending and torsional stiffness to withstand the projected static and dynamic forces etc. The frame can also be modular in form, readily manufactured and shipped in pieces for ease of transportation and onsite assembly. The guide rails 4, 6 may also be welded to the support structures 105a-c, which is generally not possible for existing linear motor systems. In other embodiments the guide rails may be mounted to or integrated in a truss, or lattice system and/or may be integrated into the machine frame or chassis.

Unlike the previous Figures, in FIG. 10 mover-mounted devices 150, 152 are schematically illustrated as mounted to the body (in this case a face plate), of each one of the first and second transport modules 8, 10 respectively. Specifically, the first mover-mounted device 150 is mounted to a first module body 24 (of the first transport module 8). A second mover-mounted device 152 is mounted to a second transport module body 26 of the second transport module 10.

The mover-mounted devices 150, 152 may be any one of a number of different devices, for example handling, gripping, transporting, manipulating etc. for example items, articles, products, packaging materials and/or sensors, processes, inspections etc. applied thereon. The mover-mounted devices may perform functions such as grasping, raising, holding, forming, pressing or otherwise manipulating products. Products include primary packaging such as bottles and/or cans, and secondary packaging such as cardboard blanks, packaging components (plain and/or pre-glued sub-assembles etc., and/or cardboard boxes etc. Each of the mover-mounted devices 150, 152 may comprise one or more electrical devices powered via the same or a separate inductive power supply as that of the Transport Module. Each electrical device may be controlled remotely by the central Master Controller (PLC or IPC) via the Transport Module mounted wireless Client (FIG. 12a) or via a local Transport Module mounted Controller addressed by the central Master Controller (PLC or IPC) via the Transport Module mounted wireless Client (FIG. 12b). The Transport Module mounted electrical devices could comprise any electrically powered and controlled devices such as and not limited to linear and/or rotary actuators, generators, motors, pumps, compressors, vacuum pumps/generators, sensors (analogue/digital), switches, solenoids, modulating (e.g. control) devices, cameras, valves, heaters, coolers, vibrators, illuminators, irradiators, instruments etc. Further details of the mover-mounted devices 150, 152 are not of particular relevance to this application. However, by virtue of the independently controllable transport modules 8, 10, the system 2 can be used to provide efficient transportation of items, articles, products and/or materials manipulated and/or handled by the mover-mounted devices 150, 152. The ability to select the mover-mounted devices 150, 152 depending upon the operation to be carried out increases the flexibility of the system 2. Furthermore, the mover-mounted devices 150, 152 can be switched over the lifetime of the system 2. The mover-mounted devices 150, 152 can also be selected to assist with the scaling of the system 2 as needed (e.g. each mover-mounted device 150, 152 may interact with a plurality of articles, items, parts, products and/or packaging materials etc.).

Turning to FIG. 11, the second transport module 10 is shown with the first transport module 8 disposed behind it (e.g. into the plane of the page). As such, only a mover-mounted device 152 of the second transport module 10 is visible. Many of the features of FIG. 11 have previously been described in detail and will therefore not be described again. However, FIG. 11 does show a power supply rail 19, mounted to the support structure 105c, interacting with the conductor 18 of the inductive power module 16 of the second transport module 10. Specifically, a U-shaped recess 17 of the conductor 18 is configured to receive the power supply rail 19 (e.g. conductor cable) therein. Alternating power can thereby be transferred wirelessly, (e.g. in a contactless manner), from the power rail 19 to the conductor (e.g. pickup) 18 and so inductive power module 16 and second transport module 10 (and any mover mounted electrical devices mounted thereon). As will be appreciated from FIG. 11, the power supply rail 19 generally follows the (curvilinear) guide rails 4, 6 (e.g. extends parallel to) along which the transport module translates.

Turning to FIG. 12, a schematic illustration of the product transport system 2 is provided. The FIG. 12 schematic indicates the various interactions between subsystems which make up the overall product transport system 2. It will be appreciated that the FIG. 12 schematic is also applicable to the system 102 shown in FIGS. 7 to 9.

The first guide rail 4 is labelled in FIG. 12, although it will be appreciated that the interactions shown in FIG. 12 may equally apply to the second guide rail or another guide rail (depending upon the system in question, and the transport module in question). Further, a number of subsystems which are mounted to the transport module 8 are indicated as being bound by the dashed line box.

As previously described, the transport module 8 comprises the transport module body 24 to which various other components are mounted. Mounted to the transport body 24 is the first mover-mounted device 150 and the rotary drive motor 12. Also mounted to the first transport body 24 is the inductive power module 16 and the control module 20. A first guide wheel 32 is also indicated as forming part of the first transport module 8 and engaging the first guide rail 4. Further, drive wheel 13 also forms part of the transport module 8 and is in torque communication 154 with the rotary drive motor 12.

The rotary drive motor 12 is electrically connected to the inductive power supply 16 and also to the control module 20. The inductive power module 16 is further electrically connected to the mover-mounted device 150 and control module 20. As previously described, the inductive power module 16 receives electrical power wirelessly from the power supply rail 19.

Also forming part of the first transport module 8 is a position sensing module 156 configured to detect the position of the transport module 8. The position sensing module 156 may be used to determine the position of the transport module 8 relative to the rail 4 or in space generally (e.g. using a radio or GPS system). The position sensing module 156 may be an encoder. The position sensing module 156 may further, or alternatively, provide feedback indicating the speed and/or acceleration of the transport module (e.g. to a master controller of the overall system). The position sensing module 156 is electrically connected to the control module 20 and may be powered off the inductive power supply 19. The control module 20 further comprises a wireless receiver 22 which, in some embodiments, may also provide a wireless transmitter functionality (e.g. it may be bi-directional). The wireless receiver 22 is configured to receive a control signal 158 from a wireless transmitter 160. The wireless transmitter 160 is electrically connected to a master controller 162 which determines the overall control of system 2. It will be appreciated that FIG. 12 schematically depicts one example of the control system associated with the product transport system 2 and for a single transport module 8 only. It will be appreciated that the product transport system 2 may comprise a plurality of transport modules and may comprise a plurality of guide rails.

The control module 20 can issue commands, by way of control signals, to the mover-mounted device 150, the rotary drive motor 12 and the position sensing module 156. The control module 20 can also communicate with the master controller 162 via the wireless transmitter 160 and wireless receiver 22. The control module 20 can also receive information, by way of control signals, from the mover-mounted device 150, the rotary drive motor 12 and the position sensing module 156. The control module 20 may be described as being powered by the inductive power module 16.

The inductive power module 16 and control module 20 may power and control, respectively, the mover-mounted device 150. The mover-mounted device 150 may be a smart mover-mounted device, which may be in synchronous and/or asynchronous communication with the control module 20.

Owing to the interaction via the wireless receiver, between the control module 20 and the master controller 162, each transport module 8 is independently controllable.

The system may be used in both precise in-machine operations (for example) as well as lower precision environments (e.g. moving products between machines, production lines and/or departments and/or buildings). Advantageously, lower precision guide rail may be used for lower precision environments, whilst higher precision guide rail be used for more precise operations. The system may be applied to open and closed loop control environments (and so utilise open and closed loop guide rails/tracks).

The present invention has been described above purely by way of example. Modifications in detail may be made to the present invention within the scope of the claims as appended hereto. Furthermore, features from one example may be combined with an alternative example unless such a combination is explicitly precluded.

1. A transport module for a product transport system, wherein the transport module is mountable on a curvilinear guide rail, the transport module comprising:
a rotary drive motor in torque communication with a drive wheel;
a power module electrically connected to the rotary drive motor and configured to receive electrical power contactlessly from a power supply rail, wherein the power module is configured to be untethered with respect to the power supply rail; and
a control module in communication with the rotary drive motor, the control module comprising a bi-directional wireless communication device configured to receive a control signal and transmit status data; and
a position sensing module configured to detect the position of the transport module.

2. The transport module according to claim 1, wherein the drive wheel comprises a spur pinion or roller pinion for engaging a rack or roller rack associated with the guide rail.

3. The transport module according to claim 1, further comprising a guide wheel engageable with the guide rail.

4. The transport module according to claim 3, wherein the transport module comprises a first array of guide wheels engageable with the guide rail, the first array of guide wheels comprising the guide wheel.

5. The transport module according to claim 4, wherein at least a subset of the first array of guide wheels is circumferentially offset with respect to the drive wheel.

6. The transport module according to claim 3, wherein the guide rail is a first guide rail, and wherein the transport module further comprises a second array of guide wheels engageable with a second guide rail.

7. The transport module according to claim 3, wherein at least one guide wheel is urgeable into engagement with a respective guide rail by a biasing member.

8. The transport module according to claim 7, wherein at least one guide wheel is rotatably mounted to a first end of a wheel support, the wheel support is pivotally mounted about a fulcrum, and a second end of the wheel support is biased, by the biasing member, such that the at least one guide wheel is urgeable into engagement with the guide rail.

9. The transport module according to claim 1, wherein at least a contact surface of the drive wheel, engageable with the guide rail, is polymeric.

10. A product transport system, the product transport system comprising:
a first transport module according to any preceding claim;
a guide rail; and
a power supply rail;
wherein the first transport module is mounted to, and movable along, the guide rail; and
wherein the power module is configured to receive electrical power contactlessly from the power supply rail.

11. The product transport system according to claim 10, further comprising a second transport module according to claim 1.

12. The product transport system according to claim 11, wherein the first and second transport modules are independently controllable.

13. The product transport system according to claim 11, wherein a pitch between the first and second transport modules is less than around 54 mm.

14. The product transport system according to claim 10, wherein the guide rail is a first guide rail, the system further comprising a second guide rail, wherein the drive wheel of the first transport module is engageable with the first guide rail, and wherein the drive wheel of the second transport module is engageable with the second guide rail.

15. The product transport system according to claim 10, wherein the guide rail defines a complex path.
